(19) United States
(12) Patent Application Publication
(10) Pub. No.: US 2009/0277804 A1
(43) Pub. Date: Nov. 12, 2009

(54) ELECTROCHEMICAL SEPARATION OF [18F] FLUORIDE FROM [180] WATER

(76) Inventor: Alan Peter Clarke, Oslo (NO)

Correspondence Address: GE HEALTHCARE, INC., IP DEPARTMENT 101 CARNEGIE CENTER, PRINCETON, NJ, 08540-6231, US

(21) Appl. No.: 12/306,261

(22) PCT Filed: Jun. 28, 2007
(86) PCT No.: PCT/GB2007/002423

§ 371 Date: Dec. 23, 2008

Related U.S. Application Data
(60) Provisional application No. 60/817,943, filed on Jun. 30, 2006.

(51) Int. Cl. C02F 1/461; C25B 9/00

(52) U.S. Cl. 205/742; 204/275.1

(57) ABSTRACT

A method of electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions. The present invention also provides for an apparatus for separating [¹⁸F] fluoride from [¹⁸O] water. Kit claims for separating [¹⁸F] fluoride from [¹⁸O] water are also provided

### FIELD OF THE INVENTION

The present invention relates to a novel nucleophilic fluorination apparatus, and a kit for making [¹⁸F] fluorinated solutions whereby electrochemically separating [¹⁸F] fluoride from [¹⁸O] water by using electrodes to selectively adsorb, desorb, or degrade impurities resulting from unwanted side reactions.

### BACKGROUND OF THE INVENTION

The first major step of nucleophilic radiofluorination is drying the aqueous [¹⁸F] fluoride which is commonly performed in the presence of a phase-transfer cataylst under azeotropic evaporation conditions (Coenen et al., J. Labelled Compd. Radiopharm., 1986, vol. 23, pgs. 455-467). [¹⁸F] fluoride dissolved in the target water is often adsorbed on an anion exchange resin and eluted, for example, with a potassium carbonate solution (Schlyer et al., Appl. Radiat. Isot., 1990, vol. 40, pgs. 1-6). The subsequent azeotropic drying is of a water-solvent mixture in which the cryptate is used to solubilise the fluoride. One cryptate that is available commercially is 4,7,13,16,21,24-hexaoxa-1,10-diazabicyclo [8,8,8] hexacosan, with the tradename Kryptofix 222. Cryptate is a cage-like agent that has three ether ribs joining the nitrogens at each end. Alkali metals can be held very strongly inside the cage.

Furthermore, [¹⁸F] fluoride produced from [¹⁸O] water irradiated by a proton beam from a cyclotron is widely used in the synthesis of radio-pharmaceuticals for positron emission tomography. (Hamacher et al., Appl. Radiat. Isot., 2002, vol. 56, pgs. 519-523). The [¹⁸F] fluoride is usually separated from the [¹⁸O] water before the synthesis in order to reuse the [¹⁸O] water repeatedly. In this process, the efficiency of the recovery of the [¹⁸F] fluoride as well as the purity of the recovered [¹⁸F] fluoride is important. The contamination of the [¹⁸F] fluoride causes a decrease in the efficiency of the synthesis of the [¹⁸F] fluorine-labeled chemicals.

Additionally, an electrochemical method was investigated by Alexoff et al. (Alexoff et al., Appl. Radiat. Isot., 1989, vol. 40, pgs. 1-6). They used a platinum cathode and an anode cell of vitreous carbon to separate [¹⁸F] fluoride from [¹⁸O] water. The [¹⁸F] fluoride activities of 0.5-5 mCi was electro-deposited on the surface of the anode cell and then the [¹⁸O] water was discharged from the cell. The pure water was then transferred into the cell and an inverted voltage was applied so that the electro-deposited [¹⁸F] fluoride emitted into the water. This method can recover high purity [¹⁸F] fluoride and ¹⁸O-enriched water. However, the efficiency of recovery is only 67% and the electrochemical method is not suitable for routine application in large production runs where fluoride must be recovered in large quantities.

Saito et al. reported that considerably higher efficiency is possible. (Saito et al., Appl. Radiat. Isot., 2001, vol. 55, pgs. 755-758). They used an electrochemical method for producing the [¹⁸F] fluoride spot source of a slow positron beam from [¹⁸O] water. The electro-deposition on a graphite rod or a platinum rod was performed with [¹⁸F] fluoride of activities 150-227 mCi (5.55-8.40 GBq). The deposited [¹⁸F] fluoride was then emitted into ultra-pure water. The efficiency of the electro-deposition and the fraction of emission were measured. The transfer of impure radio-isotopes was also investigated. The best results of the efficiency for the electro-deposition for 5 minutes was 97% and that for the electro-emission for 5 minutes was 89%. In using the aforementioned method, the [¹⁸O] water is expected to be reused much more easily by this method than by the ion-exchange resin method. Saito et al. also reported that the metal impurities contained in the [¹⁸F] fluoride solution were considerably reduced by using this method.

In Hamacher et al., an electrochemical recovery of n.c.a. [¹⁸F] fluoride in dipolar aprotic solvents and solutions of phase transfer catalyst is discussed. (Hamacher et al., Appl. Radiat. Isot., 2002, vol. 56, pgs. 519-523). This disclosed recovery process allows the use of a specifically designed electrochemical cell as a reaction vessel for n.c.a. nucleophilic ¹⁸F-fluorinations subsequent to [¹⁸F] fluoride deposition. In other words, Hamacher et al. uses an electrochemical cell within a chamber that comprises two electrodes across which an electric field is applied. The [¹⁸F] fluoride anions are adsorbed onto the surface of the anode while the [¹⁸O] water is flushed from the electrode chamber. Hamacher et al. further conclude that a specifically designed electrochemical cell is generally useful for n.c.a. nucleophilic ¹⁸F-radiotracer syntheses. Especially in the case of base labeled products like butyrophenones, the electrochemical cell allows cryptate catalyzed ¹⁸F-fluorination in the presence of weak basic, less nucleophilic salts like potassium oxalate or triflate.

Moreover, nucleophilic fluorination of glucose to form 2-[¹⁸F]fluoro-2-deoxy-D-glucose (“[¹⁸F] FDG”) requires anhydrous conditions. Accordingly, like all the other aforementioned examples, [¹⁸F] fluoride must be separated from [¹⁸O] water. Currently, the only way to achieve [¹⁸F] fluoride in anhydrous conditions is by an ion-exchange process where the [¹⁸F] fluoride is first retained on an anion-exchange resin and is then eluted off in an aqueous-solvent mixture containing a cryptand. This solvent mixture containing the cryptand is then evaporated to dryness prior to the fluorination step. A cryptand herein is a phase-transfer agent used to improve the solubility of [¹⁸F] fluoride in non-aqueous environments. Furthermore, the requirement for some water to be present in the elution of [¹⁸F] fluoride from the resin results in longer times for the evaporation step. All such time delays reduce rapid separation of [¹⁸F] fluoride into a totally anhydrous solvent and thus reduce the yield of [¹⁸F] FDG.

Accordingly, there is a need for creating an electrochemical approach that can use alternative materials such as gold, platinum, or silver electrodes in which these electrodes could be tailored to inhibit electrochemical reactions with precursors and at the same time allow a higher potential to be maintained within a chamber thus improving the efficiacy of fluoride adsorption and desorption. Furthermore, these electrodes can also be used to selectively adsorb, desorb, or degrade impurities from unwanted side reactions.

Discussion or citation of a reference herein shall not be construed as an admission that such reference is prior art to the present invention.

### SUMMARY OF THE INVENTION

In view of the needs of the prior art, the present invention provides an electrochemical fluorination method of separating [¹⁸F] fluoride from [¹⁸O] water in a device with two or more electrodes whereby the electrodes are used selectively to adsorb, desorb, or degrade impurities resulting from unwanted side reactions.

Unlike previous methods wherein the [¹⁸F] nucleophilic fluoride anions are adsorbed or taken up onto the surface of the electrode of positive polarity while the [¹⁸O] water is flushed from the electrode chamber, the present invention utilizes alternative electrode materials that can be tailored to inhibit electrochemical reactions with precursors while simataneously providing a higher voltage potential to be maintained within the chamber thus improving the efficiency of fluoride desportion. Additionally, unlike previous methods, the present invention demonstrates nucleophilic fluorination reactions within the chamber and then use the electrodes of the chamber to selectively adsorb, desorb, or degrade impurities resulting from unwanted side reactions wherein these electrodes inhibit electrochemical reactions of precursors from occuring.

The present invention also depicts a method of separating [¹⁸F] fluoride from [¹⁸O] water in a device comprising: two or more electrodes, wherein said device allows entry and exit of solutions within a chamber wherein an electric field is applied over said electrodes whereby the electrodes consists of an electrode material wherein the electrode material inhibits electrochemical reactions of precursors from reacting thus forming nucleophilic [¹⁸F] fluorinated solutions is disclosed. Furthermore, the electrodes within the chamber adsorb, desorb, or degrade impurities of unwanted side reactions. These electrodes inhibit electrochemical reactions of precursors from occuring.

The present invention further provides for an apparatus for forming nucleophilic [¹⁸F] fluorinated solutions by electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consists of an electrode material wherein the electrode material inhibits electrochemical reactions of precursors from reacting thus forming nucleophilic [¹⁸F] fluorinated solutions is disclosed. It is important to note here that the electrodes within the chamber adsorb, desorb, or degrade impurities of unwanted side reactions. These electrodes inhibit electrochemical reactions of precursors from reacting.

The present invention additionally provides for a kit for forming nucleophilic [¹⁸F] fluorinated solutions by electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consists of an electrode material wherein the electrode material inhibits electrochemical reactions of precursors from reacting thus forming nucleophilic [¹⁸F] fluorinated solutions is disclosed. It is important to note here that the electrodes within the chamber adsorb, desorb, or degrade impurities of unwanted side reactions. These electrodes inhibit electrochemical reactions of precursors from reacting.

### DETAILED DESCRIPTION OF THE INVENTION

PET imaging is a tomographic nuclear imaging technique that uses radioactive tracer molecules that emit positrons. When a positron meets an electron, they both are annihilated and the result is a release of energy in the form of gamma rays, which are detected by the PET scanner. By employing natural substances that are used by the body as tracer molecules, PET does not only provide information about structures in the body but also information about the physiological function of the body or certain areas therein. A common tracer molecule is for instance 2-fluoro-2-deoxy-D-glucose (“FDG”), which is similar to naturally occurring glucose, with the addition of an ¹⁸F-atom. Gamma radiation produced from said positron-emitting fluorine is detected by the PET scanner and shows the metabolism of FDG in certain areas or tissues of the body, e.g. in the brain or the heart. The choice of a tracer molecule depends on what is being scanned. Generally, a tracer is chosen that will accumulate in the area of interest, or be selectively taken up by a certain type of tissue, e.g. cancer cells. Scanning consists of either a dynamic series or a static image obtained after an interval during which the radioactive tracer molecule enters the biochemical process of interest. The scanner detects the spatial and temporal distribution of the tracer molecule. PET also is a quantitative imaging method allowing the measurement of regional concentrations of the radioactive tracer molecule.

Additionally, nucleophilic fluorination of glucose to form 2-[¹⁸F]fluoro-2-deoxy-D-glucose (“[¹⁸F] FDG”) requires anhydrous conditions. Accordingly, [¹⁸F] fluoride must be separated from [¹⁸O] water. Currently, the only way to achieve [¹⁸F] FDG by anhydrous conditions is by an ion-exchange process where the [¹⁸F] fluoride is first retained on an anion-exchange resin and is then eluted off in an aqueous-solvent mixture containing a cryptand. This solvent mixture containing the cryptand is then evaporated to dryness prior to the fluorination step. A cryptand is a phase-transfer agent used to improve the solubility of [¹⁸F] fluoride in non-aqueous environments. Furthermore, the requirement for some water to be present in the elution of [¹⁸F] fluoride from the resin results in longer times of about 8-10 minutes for the evaporation step. All such time delays prevent a rapid separation of [¹⁸F] fluoride into a totally anhydrous solvent and reduce the yield of [¹⁸F] FDG.

The current invention sets forth several advantages over previous methods. The present invention utilizes alternative electrode materials that can be tailored to inhibit electrochemical reactions with precursors while simataneously providing a higher voltage potential to be maintained within the chamber thus improving the efficiency of fluoride desportion. Additionally, unlike previous methods, the present invention demonstrates fluorination reactions that could be preformed within the electrochemical chamber provided the precursors withstand the applied electric fields. Additionally, the term nucleophilic as defined herein means being an electron donor.

Below a detailed description is given of a method for producing a nucleophilic fluorination electrochemical method by separating [¹⁸F] fluoride from [¹⁸O] water by using electrodes to adsorb, desorb, or degrade impurities resulting from unwanted side reactions. The term adsorb as used herein is defined as to take up. The term desorb is defined as to remove and the term degrade is used herein to mean to lower to a less effective level. The present invention also relates to preparing a nucleophilic fluorination electrochemical apparatus by separating [¹⁸F] fluoride from [¹⁸O] water. The present invention further relates to kits for producing a nucleophilic fluorination electrochemical method and apparatus by separating [¹⁸F] fluoride from [¹⁸O] water.

In one embodiment of the present invention a method of separating [¹⁸F] fluoride from [¹⁸O] water in a device comprising:

two or more electrodes, wherein said device allows entry and exit of solutions within a chamber wherein an electric field is applied over said electrodes whereby the electrodes consist of an electrode material wherein the electrode material inhibits electrochemical reactions of precursors from occuring thus forming nucleophilic [¹⁸F] fluoride solutions is disclosed. The nucleophilic [¹⁸F] fluoride is adsorbed electrostatically on the positively charged electrode. Additionally, the electrodes within the chamber adsorb, desorb, or degrade impurities of unwanted side reactions. These electrodes inhibit electrochemical reactions of precursors from reacting thus enabling one to both perform fluorination reactions and increase the purity of obtaining nucleophilic [¹⁸F] fluoride solutions to at least about 98%.

Alternatively, it is possible to have an array of electrodes within said device. It would also be possible to apply a potential waveform to the electrodes of the device in order to achieve temporal control of electrode reactions. It would also be possible to have additional modified electrodes within the device that have other characteristics such as other electrode materials and surfaces not disclosed herein. These alternative incorporations to said device would better enable the electrochemical cell to be adaptive to any radiolabeled reactions taking place within said cell. The addition of modified electrodes in the device would enable one to target either or both the molecule of interest and unwanted impurities.

Yet another embodiment of the present inventive method describes the device as encompassing porous or planar electrodes. Porous electrodes provide a much larger surface area than planar electrodes. This larger surface area would improve the efficiency of [¹⁸F] fluoride recovery from [¹⁸O] water. Accordingly, these porous electrodes are beneficial for exhaustive electrochemical scavanging of large volumes of solution. Similarly, the large surface area of porous electrodes would improve the efficiency of selective adsorption, desorption or electrochemical degradation of impurities.

A further embodiment of the present inventive method describes the chamber as an electrochemical cell that comprises the electrodes and flow path for the solutions that will be entering and exiting said chamber.

Still another embodiment of the present method encompasses said solutions as being [¹⁸F] fluoride, [¹⁸O] water, a similar solution thereof, or a combination of [¹⁸F] fluoride and [¹⁸O] water.

Yet another embodiment of said present method describes that the electrochemical reactions of precursors occur by electrochemically-inducing fluorination reactions and that the [¹⁸F] fluoride solutions are used to radiolabel [¹⁸F] fluorinated species. Examples of electrochemically-induced fluorination reactions used herein are monosubstituted aromatic compounds that are performed with [¹⁸F] fluoride using potentiostatic anodic oxidation on platinum electrodes in an undivided cell in acetonitrile with a mixture of Et₃N_{—}3HF/Et₃N_HCl as an electrolyte.

Still in a further embodiment of the present inventive method, the electrodes within the chamber adsorb, desorb, or degrade impurities in order to perform fluorination reactions and the electrode material is gold, silver or platinum.

Yet another embodiment of the present inventive method encompasses electrochemical reactions that require that the electrode material act as a catalyst. The solvent and electrolyte in the cell will also impact on what can or can not occur at the electrode surface. Accordingly, by using specific choices of electrode material in the device, it is possible that radiolabelling reactions can be cleaned up electrochemically and thus one can obtain a more efficient radiolabelled product.

In another embodiment of the present inventive method the [¹⁸F] fluoride solutions are used to radiolabel [¹⁸F] fluorinated species. The radiolabelled [¹⁸F] fluorinated species are then used as an imaging agent in a patient and the imaging agent is viewed by an imaging technique such as a PET scanner. The subsequent images of the patient developed with PET are used to evaluate a variety of diseases.

The present invention further provides for an apparatus for forming nucleophilic [¹⁸F] fluorinated solutions by electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions is disclosed. Furthermore, the electrodes within the chamber adsorb, desorb, or degrade impurities of unwanted side reactions. These electrodes inhibit electrochemical reactions of precursors from occuring.

Yet another embodiment of the present inventive apparatus describes the device as encompassing porous, or flow-through, electrodes or planar electrodes. Porous electrodes provide a much larger-surface area. This larger surface area would improve the efficiency of [¹⁸F] fluoride recovery from [¹⁸O] water. Accordingly, these porous electrodes are beneficial for exhaustive electrochemical scavanging of large volumes of solution. Similarly, the large surface area of porous electrodes would improve the efficiency of selective adsorption, desorption or electrochemical degradation of impurities.

A further embodiment of the present inventive apparatus describes the chamber as an electrochemical cell that comprises the electrodes and flow path for the solutions that will be entering and exiting said chamber.

Still another embodiment of the present apparatus encompasses said solutions as being [¹⁸F] fluoride, [¹⁸O] water, a similar solution thereof, or a combination of [¹⁸F] fluoride and [¹⁸O] water.

Yet another embodiment of said present apparatus describes that the electrochemical reactions of precursors occur by electrochemically-inducing fluorination reactions and that the [¹⁸F] fluoride solutions are used to radiolabel [¹⁸F] fluorinated species.

In an additional embodiment of the present inventive apparatus, the electrodes within the chamber adsorb, desorb, or degrade impurities in order to perform fluorination reactions and the electrode material is gold, silver or platinum.

Furthermore, in another embodiment of the present inventive apparatus encompasses that the electrochemical reactions require that the electrode material act as a catalyst. The solvent and electrolyte in the cell will also impact on what can or can not occur at the electrode surface. Accordingly, by using specific choices of electrode material in the device, it is possible that radiolabelling reactions can be cleaned up electrochemically and thus one could obtain a more efficient radiolabelled product.

In another embodiment of the present inventive apparatus the [¹⁸F] fluoride solutions are used to radiolabel [¹⁸F] fluorinated species. The radiolabelled [¹⁸F] fluorinated species are then used as an imaging agent in a patient and the imaging agent is viewed by an imaging technique such as a PET scanner. The subsequent images of the patient developed with PET are used to evaluate a variety of diseases.

The present invention also provides for a kit for forming nucleophilic [¹⁸F] fluoride solutions by electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from occuring thus forming nucleophilic [¹⁸F] fluoride solutions is disclosed. It is important to note here that the electrodes within the chamber adsorb, desorb, or degrade impurities of unwanted side reactions. These electrodes inhibit electrochemical reactions of precursors from occuring thus enabling one to both perform fluorination reactions and increase the purity of obtaining nucleophilic [¹⁸F] fluoride solutions to at least about 98%.

Yet another embodiment of the present inventive kit describes the device as encompassing porous, or flow-through, electrodes or planar electrodes. Porous electrodes provide a much larger surface area. This larger surface area would improve the efficiency of ¹⁸F recovery from ¹⁸O water. Accordingly, these porous electrodes are beneficial for exhaustive electrochemical scavanging of large volumes of solution. Similarly, the large surface area of porous electrodes would improve the efficiency of selective adsorption, desorption or electrochemical degradation of impurities.

A further embodiment of the present inventive kit describes the chamber as an electrochemical cell that comprises the electrodes and flow path for the solutions that will be entering and exiting said chamber.

Still another embodiment of the present kit encompasses said solutions as being [¹⁸F] fluoride, [¹⁸O] water, a similar solution thereof, or a combination of [¹⁸F] fluoride and [¹⁸O] water.

Yet another embodiment of said present kit describes that the electrochemical reactions of precursors occur by electrochemically-inducing fluorination reactions and that the [¹⁸F] fluoride solutions are used to radiolabel [¹⁸F] fluorinated species.

Still in a further embodiment of the present inventive kit, the electrodes within the chamber adsorb, desorb, or degrade impurities in order to perform fluorination reactions and the electrode material is gold, silver or platinum.

Yet another embodiment of the present inventive kit encompasses that the electrochemical reactions require that the electrode material act as a catalyst. The solvent and electrolyte in the cell will also impact on what can or can not occur at the electrode surface. Accordingly, by using specific choices of electrode material in the device, it is possible that radiolabelling reactions can be cleaned up electrochemically and thus one could obtain a more efficient radiolabelled product.

In another embodiment of the present inventive kit the [¹⁸F] fluoride solutions are used to radiolabel [¹⁸F] fluorinated species. The radiolabelled [¹⁸F] fluorinated species are then used as an imaging agent in a patient and the imaging agent is viewed by an imaging technique such as a PET scanner. The subsequent images of the patient developed with PET are used to evaluate a variety of diseases.

Yet in another embodiment of the present inventive method, apparatus, and kit an optional array of electrodes are added within said device. These optional arrays of electrodes aid to enable the electrochemical cell to be adaptive to any radiolabeled reactions taking place within said cell.

The diagnostic use of separating [¹⁸F] fluoride from [¹⁸O] water in a device is also disclosed. This separation comprises:

two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions are disclosed. The nucleophilic [¹⁸F] fluoride solutions are adsorbed electrostatically on the positively charged electrode is also disclosed. Furthermore, the electrodes within the chamber adsorb, desorb, or degrade impurities of unwanted side reactions. These electrodes inhibit electrochemical reactions of precursors from occuring thus enabling one to both perform fluorination reactions and increase the purity of obtaining nucleophilic [¹⁸F] fluoride solutions to at least about 98%.

Still in a further embodiment of the present invention, an imaging technique such as PET is to be used through out the diagnostic use claims.

The diagnostic use of an apparatus for separating [¹⁸F] fluoride from [¹⁸O] water in a device comprising: two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions are disclosed. The electrodes within the chamber adsorb, desorb, or degrade impurities of unwanted side reactions is disclosed as well.

The diagnostic use of a kit for separating [¹⁸F] fluoride from [¹⁸O] water in a device comprising: two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions are disclosed. The electrodes within the chamber adsorb, desorb, or degrade impurities of unwanted side reactions is also disclosed.

Furthermore, an optional array of electrodes is added within said device to the diagnostic use of a method, apparatus, and kit claims. These optional arrays of electrodes aid to enable the electrochemical cell to be adaptive to any radiolabeled reactions taking place within said cell. Additionally, an optional waveform (i.e. specified sequence) of different potential steps to control electrochemical reactions can be used as well to aid in enabling the electrochemical cell to be adaptive to radiolabeled reactions taking place in the cell.

### General Description of Obtaining Nucleophilic [¹⁸F] Fluoride Solutions

A method, apparatus, and a kit for electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions.

### Specific Embodiments, Citation of References

The present invention is not to be limited in scope by specific embodiments described herein. Indeed, various modifications of the inventions in addition to those described herein will become apparent to those skilled in the art from the foregoing description. Such modifications are intended to fall within the scope of the appended claims.

Various publications and patent applications are cited herein, the disclosures of which are incorporated by reference in their entireties.

1. A use for electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions.

2.-13. (canceled)

14. An electrochemical apparatus for separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions.

15. The apparatus according to claim 14, wherein the electrodes within the chamber are used to adsorb, desorb, or degrade impurities in order to perform fluorination reactions.

16. The apparatus according to claim 14, wherein the electrodes within the chamber adsorb, desorb, or degrade impurities resulting from unwanted side reactions.

17. (canceled)

18. The apparatus according to claim 14, wherein the chamber is an electrochemical cell which comprises said electrodes and flow path for the solutions that will be entering and exiting said chamber.

19. The apparatus according to claim 14, wherein said solutions are [¹⁸F] fluoride, [¹⁸O] water, a similar solution thereof, or a combination of [¹⁸F] fluoride and [¹⁸O] water.

20. The apparatus according to claim 14, wherein the electrochemical reactions of precursors occur by electrochemically-inducing fluorination reactions.

21. The apparatus according to claim 14, wherein the nucleophilic [¹⁸F] fluoride solutions are used to radiolabel [¹⁸F] fluorinated species.

22. (canceled)

23. The apparatus according to claim 22, wherein the imaging agent is viewed by an imaging technique.

24. The apparatus according to claim 23, wherein the imaging technique is a PET scanner.

25. A kit for electrochemically separating [¹⁸F] fluoride from [¹⁸O] water comprising a device that encompasses two or more electrodes, wherein said device allows entry and exit of solutions within a chamber wherein an electric field is applied over said electrodes whereby the electrodes consist of an electrode material wherein the electrode material inhibits electrochemical reactions of precursors from reacting thus forming nucleophilic [¹⁸F] fluoride solutions.

26. The kit according to claim 25, wherein the electrodes within the chamber are used to adsorb, desorb, or degrade impurities in order to perform fluorination reactions.

27. The kit according to claim 25, wherein the electrodes within the chamber adsorb, desorb, or degrade impurities resulting from unwanted side reactions.

28. (canceled)

29. The kit according to claim 25, wherein the chamber is an electrochemical cell which comprises said electrodes and flow path for the solutions that will be entering and exiting said chamber.

30. The kit according to claim 25, wherein said solutions are [¹⁸F] fluoride, [¹⁸O] water, a similar solution thereof, or a combination of [¹⁸F] fluoride and [¹⁸O] water.

31. The kit according to claim 25, wherein the electrochemical reactions of precursors occur by electrochemically-inducing fluorination reactions.

32. The kit according to claim 25, wherein the nucleophilic [¹⁸F] fluoride solutions are used to radiolabel [¹⁸F] fluorinated species.

33. (canceled)

34. The kit according to claim 33, wherein the imaging agent is viewed by an imaging technique.

35. The kit according to claim 34, wherein the imaging technique is a PET scanner.

36. (canceled)

37. The apparatus according to claim 14, wherein an optional array of electrodes are added within said device.

38. The kit according to claim 25, wherein an optional array of electrodes are added within said device.
